(19) United States
(12) Patent Application Publication
(10) Pub. No.: US 2006/0197289 A1
(43) Pub. Date: Sep. 7, 2006

(54) Air-sealing apparatus for a pneumatic tool

(75) Inventors: Chun-Chi Lai, Taichung City (TW); Chien-An Liu, Taichung City (TW)

Correspondence Address: CHARLES E. BAXLEY, ESQ., 90 JOHN STREET, THIRD FLOOR, NEW YORK, NY, 10038, US

(73) Assignee: Basso Industry Corp.

(21) Appl. No.: 11/075,001

(22) Filed: Mar. 7, 2005

(51) Int. Cl. F02F 11/00

(52) U.S. Cl. 277/594

(57) ABSTRACT

The present invention relates to an air-sealing apparatus for a pneumatic tool being disposed between abutment surfaces of two casing members of the pneumatic tool that need to be connected in an airtight fashion, wherein a rib is formed on a side surface of the air-sealing apparatus and used to abut against the abutment surfaces, and the rib will be deformed appropriately to fill clearances between the abutment surfaces, thus creating an airtight effect.

### BACKGROUND OF THE INVENTION

1. Field of the Invention

The present invention relates to an air-sealing apparatus for a pneumatic tool, and more particularly to an airtight structure disposed between two casing members of a pneumatic tool, including pneumatic nailer, pneumatic hammer, pneumatic wrench and the like tool.

2. Description of the Prior Arts

Most pneumatic tools, including pneumatic nailer, pneumatic hammer, pneumatic wrench and the like, are interiorly provided in a housing thereof with air channel, cylinder, and the like structures and components. Therefore, the housing of the pneumatic tools must be airtight, otherwise, air leak will be caused.

Referring to FIG. 1, between a housing 10 of a conventional pneumatic tool and the cap 11 thereof is usually provided with an elastic air-sealing ring 12 which is made of asbestos, rubber, metal plate covered with foam layer, and the like materials, the inherent elasticity of the air-sealing ring 12 ensures an airtight effect after the cap 11 is assembled to the housing 10.

However, the airtight effect of the conventional air-sealing ring is usually not so ideal due to the following factors:

First, the airtight effect is affected by the smoothness, therefore the airtight effect will not be ideal if the abutment surface of the housing 10 and that of the cap 11 are not smooth enough.

Second, the housing and the cap of the pneumatic tools is usually made of metal material having a relative great hardness in order to improve structural strength, inevitably, clearances will appear after the hard housing and the hard cap are held together.

Third, if the abutment portion of the housing and that of the cap are not locked evenly, it will lead to an airtight problem that only a part of the abutment portions are sealed tightly and clearances will appear at other part of the abutment portions.

The present invention has arisen to mitigate and/or obviate the afore-described disadvantages.

### SUMMARY OF THE INVENTION

The primary objective of the present invention is to provide an air-sealing apparatus for a pneumatic tool, wherein a rib is formed on a side surface of the air-sealing apparatus and used to abut against the abutment surfaces, and the rib will be deformed appropriately to fill clearances between the abutment surfaces even if the abutment surfaces are not smooth, thus improving the airtight effect.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an exploded view of a conventional air-sealing ring for a pneumatic tool;

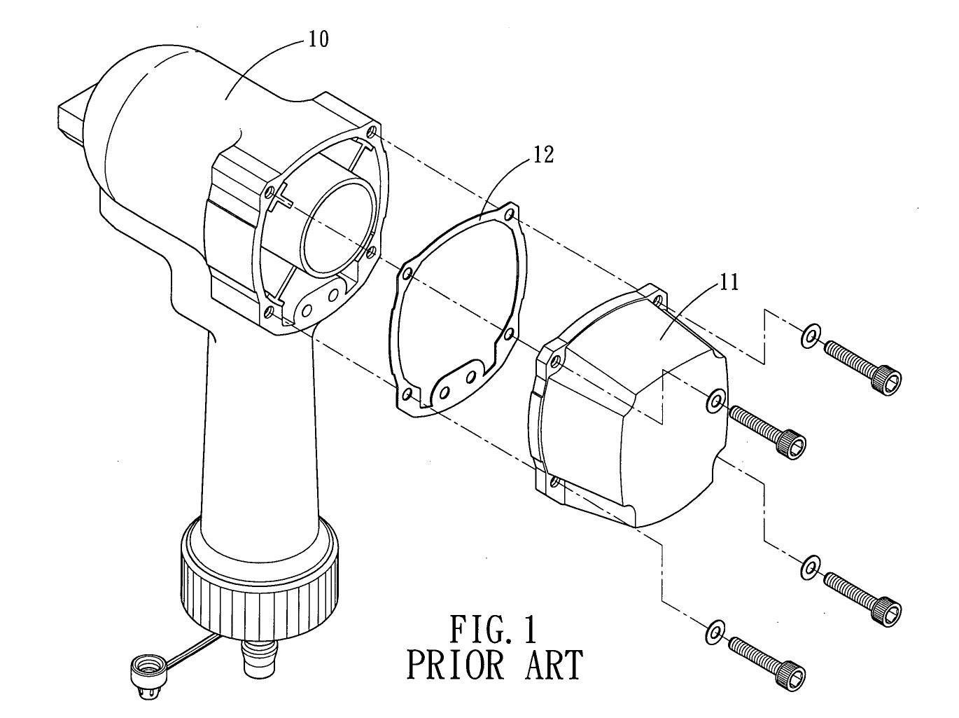

FIG. 2 is an exploded view of an air-sealing apparatus for a pneumatic tool in accordance with a first embodiment of the present invention;

FIG. 3 is an assembly view of FIG. 2;

FIG. 4 is a perspective view of the air-sealing apparatus for a pneumatic tool in accordance with the first embodiment of the present invention;

FIG. 5 is a partial amplified view of FIG. 4;

FIG. 6 is an assembly cross sectional view of the air-sealing apparatus for a pneumatic tool in accordance with the first embodiment of the present invention;

FIG. 7 is another assembly cross sectional view of the air-sealing apparatus for a pneumatic tool in accordance with the first embodiment of the present invention;

FIG. 8 is a perspective view of an air-sealing apparatus for a pneumatic tool in accordance with a second embodiment of the present invention;

FIG. 9 is a perspective view of an air-sealing apparatus for a pneumatic tool in accordance with a third embodiment of the present invention.

### DETAILED DESCRIPTION OF THE PREFERRED EMBODIMENTS

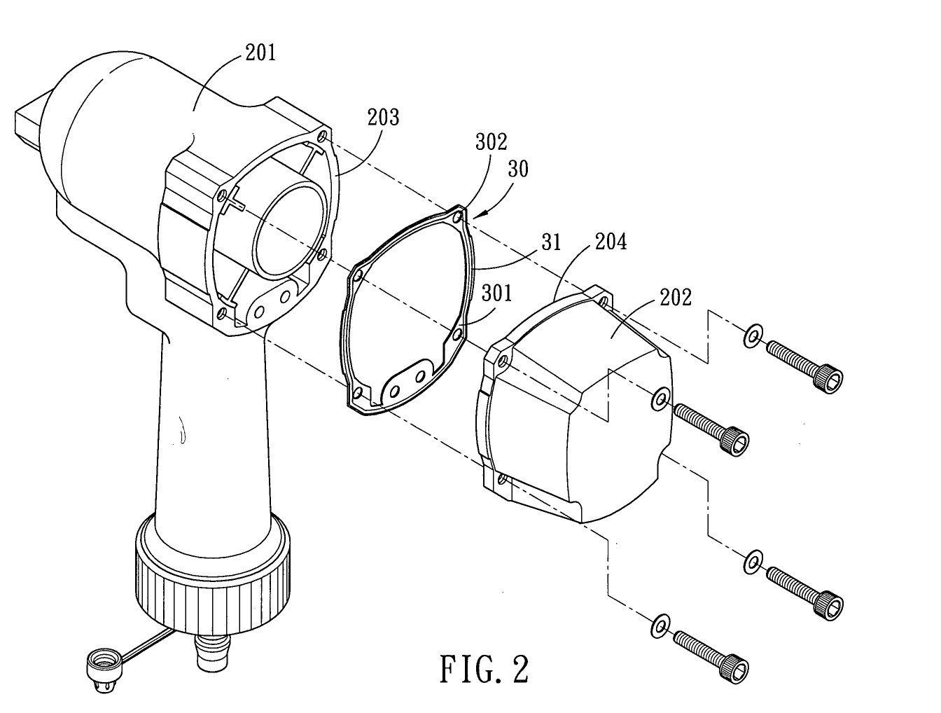

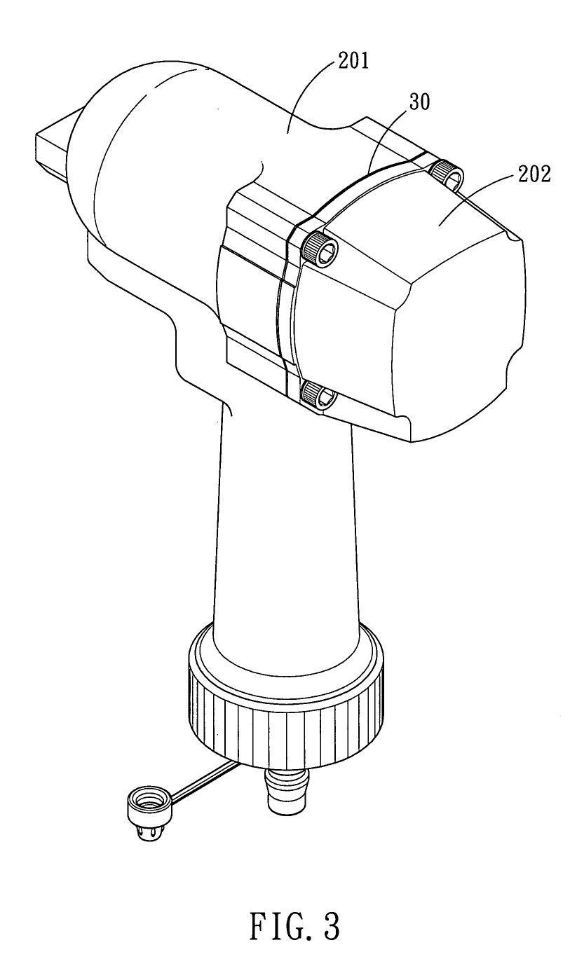

Referring to FIGS. 2-5, an air-sealing apparatus for a pneumatic tool in accordance with the present invention is shown and is disposed between any two casing members 201, 202 that need to be connected in an airtight fashion.

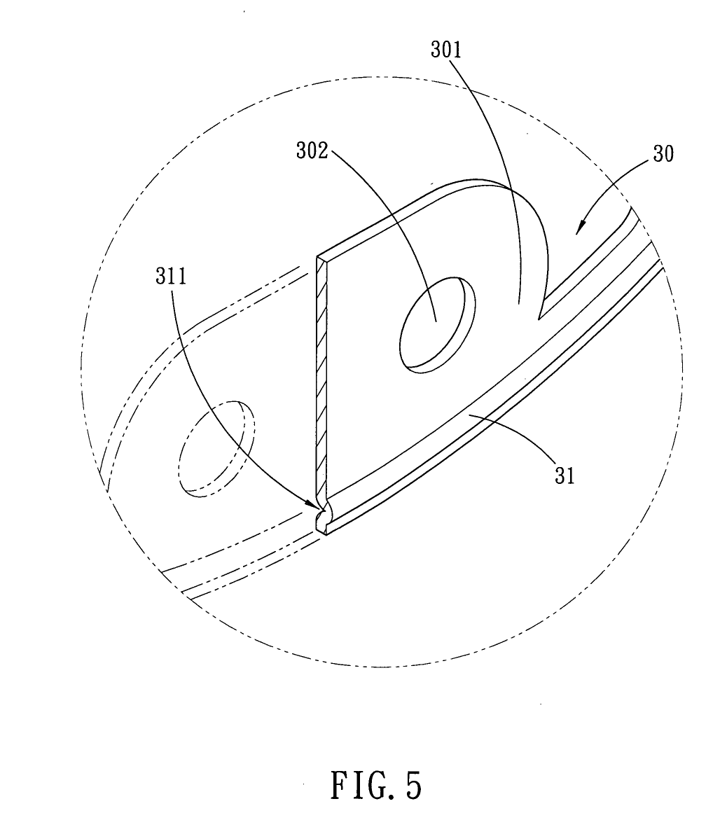

The air-sealing apparatus 30 is a ring made of asbestos, rubber, metal plate covered with foam layer, and the like elastic materials. On a side surface 301 of the air-sealing apparatus 30 is peripherally formed a rib 31 which is preferably located in the mid portion of the side surface 301. It is to be noted that the airtight effect is proportional to the elasticity of the rib 31 of the air-sealing apparatus 30. On another side surface of the air-sealing apparatus 30 is correspondingly formed a groove 311 (as shown in FIG. 5) so as to improve the elasticity of the air-sealing apparatus 30, so that the rib 31 will deform properly under pressure to fill the clearance, thus creating a perfect airtight effect.

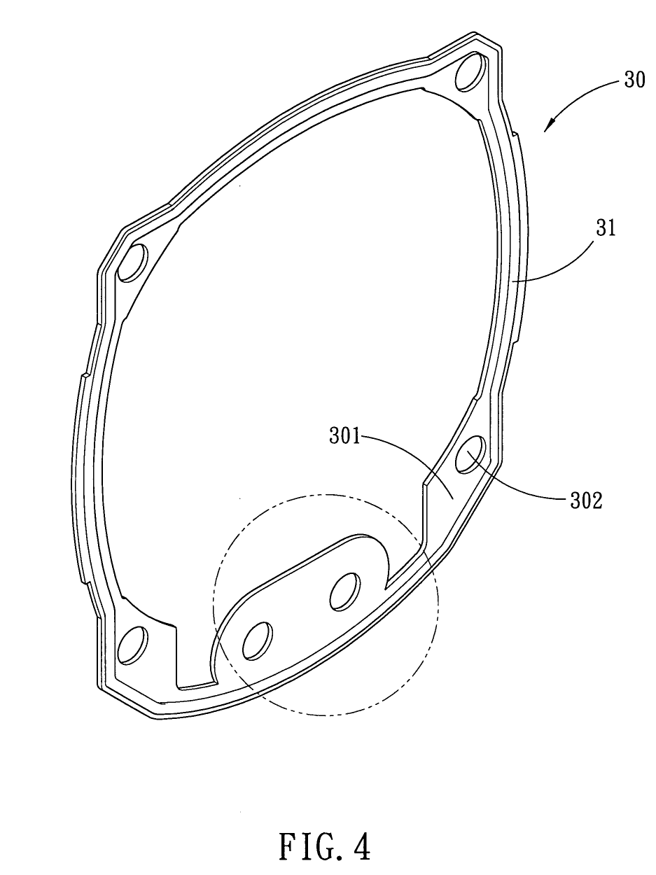

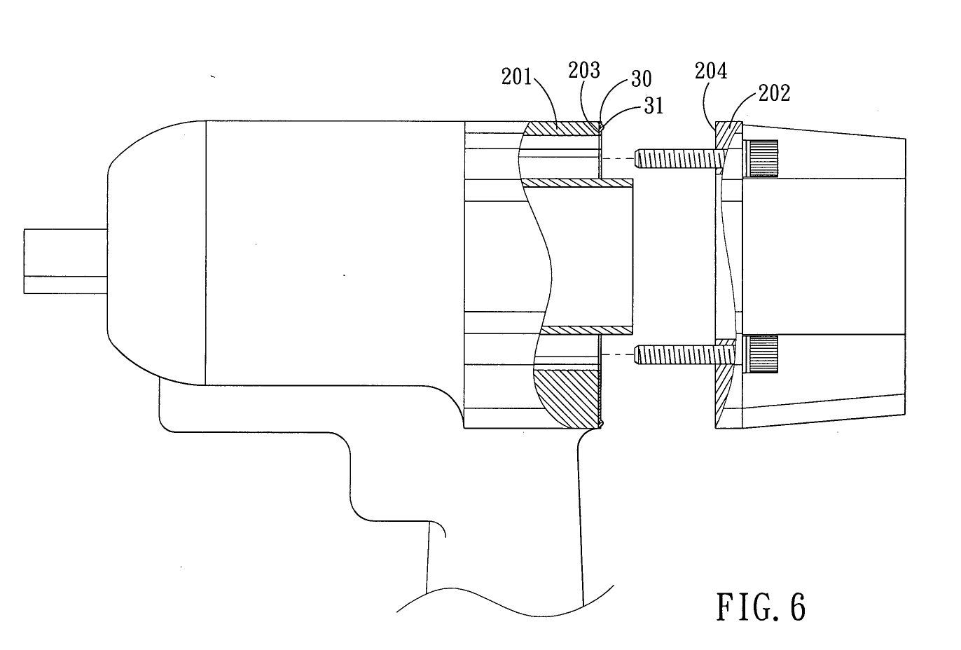

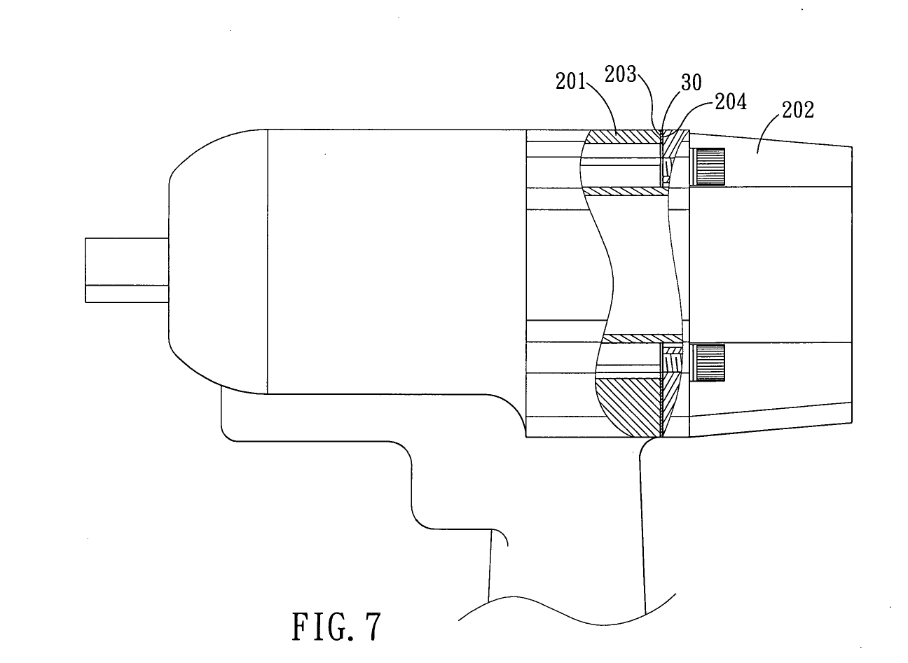

For a better understanding of the present invention, its operation and function, reference should be made to FIGS. 4-7, when the two casing members 201, 202 are being assembled together, the rib 31 of the air-sealing apparatus 30 disposed between the abutment surfaces 203, 204 of the two casing members 201, 202 will be deformed outward slightly. After the casing members 201, 202 are assembled together, the rib 31 will be pressed flat if the two abutment surfaces 203, 204 are smooth and arranged parallel to each other, creating a good airtight effect. It is to be noted that if the two abutment surfaces 203, 204 are not smooth, the rib 31 can also fill the clearance therebetween completely.

In addition, the clearances between the abutment surfaces 203, 204 are usually much less than the height of the rib 31, so that the clearances between the abutment surfaces 203, 204 caused by any factor, including hardness, uneven locking, and smoothness of the abutment surface, can be eliminated.

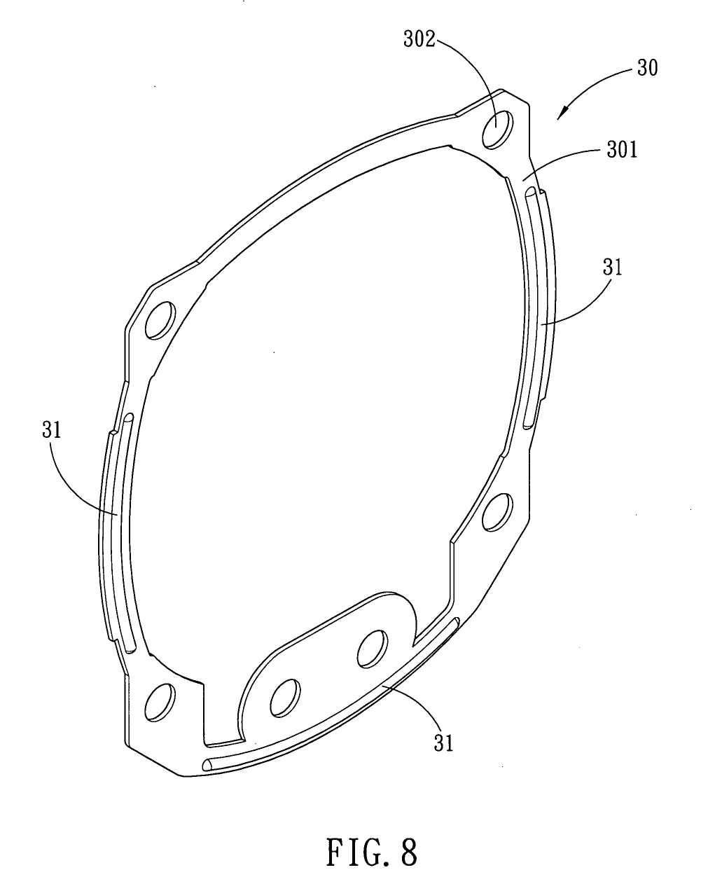

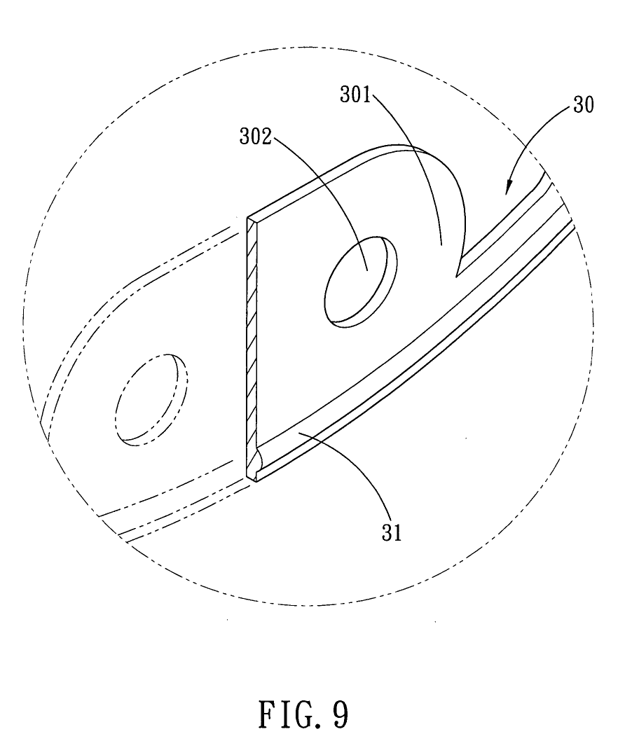

It is to be noted that the rib 31 can be annularly formed around the side surface 301 of the air-sealing apparatus 30 in a consecutive fashion (as shown in FIG. 4), and it also can be formed on the side surface 301 in an inconsecutive fashion (as shown in FIG. 8), depending on the design of the pneumatic tool. For example, the airtight effect of the air-sealing apparatus 30 near the locking holes 302 is usually better than other portion of the air-sealing apparatus 30, in this case, the rib 31 should be located at a position far from the locking holes 302, thus eliminating the uneven-locking-induced airtight problem. Furthermore, if the material of the air-sealing apparatus has a good flexibility, the air-sealing apparatus can be formed in such a manner that a side surface of the air-sealing apparatus is formed with ribs, while another side surface of the same is flat, (as shown in FIG. 9).

While we have shown and described various embodiments in accordance with the present invention, it should be clear to those skilled in the art that further embodiments may be made without departing from the scope of the present invention.

What is claimed is:

1. An air-sealing apparatus for a pneumatic tool being disposed between abutment surfaces of two casing members of a pneumatic tool for enabling the two casing members to be connected in an airtight fashion, wherein a rib is formed on a side surface of the air-sealing apparatus and used to press against the abutment surfaces, and the rib will be deformed appropriately to fill clearances between the abutment surfaces, thus creating an airtight effect.

2. The air-sealing apparatus for a pneumatic tool as claimed in claim 1, wherein the rib is located in a mid portion of the side surface of the air-sealing apparatus.

3. The air-sealing apparatus for a pneumatic tool as claimed in claim 1, wherein a groove is correspondingly formed at another side surface of the air-sealing apparatus opposite to the rib, so as to-improve the elasticity of the rib.

4. The air-sealing apparatus for a pneumatic tool as claimed in claim 1, wherein one side surface of the air-sealing apparatus is formed with the rib, while another side surface of the same is flat.

5. The air-sealing apparatus for a pneumatic tool as claimed in claim 1, wherein the rib is annularly formed around the side surface of the air-sealing apparatus in a consecutive fashion

6. The air-sealing apparatus for a pneumatic tool as claimed in claim 1, wherein the rib is formed on the side surface of the air-sealing apparatus in an inconsecutive fashion.
